(19) United States
(12) Patent Application Publication
(10) Pub. No.: US 2012/0133898 A1
(43) Pub. Date: May 31, 2012

(54) PROJECTION APPARATUS

(75) Inventors: Jui-Ping Chang, Hsinchu (TW); Chih-Hsien Tsai, Hsinchu (TW); Pei-Ching Liu, Hsinchu (TW); S-Wei Chen, Hsinchu (TW)

(73) Assignee: YOUNG OPTICS INC., Hsinchu (TW)

(21) Appl. No.: 13/171,493

(22) Filed: Jun. 29, 2011

(30) Foreign Application Priority Data
Nov. 30, 2010 (TW) 99141519

(51) Int. Cl. G03B 21/28; G03B 21/14

(52) U.S. Cl. 353/31; 353/98; 353/99

(57) ABSTRACT

A projection apparatus includes an illumination system, a light valve, a projection lens, and a first reflective unit. The illumination system provides an illumination light beam. The light valve is disposed on a transmission path of the illumination light beam and capable of converting the illumination light beam into an image light beam. The illumination light beam is transmitted to the light valve vertically. The projection lens is disposed on a transmission path of the image light beam. The first reflective unit disposed on the transmission path of the image light beam is located between the light valve and the projection lens. The first reflective unit is capable of reflecting the image light beam from the light valve to the projection lens. The image light beam reflected by the first reflective unit to the projection lens is perpendicular to the illumination light beam transmitted to the light valve.

### CROSS-REFERENCE TO RELATED APPLICATION

This application claims the priority benefit of Taiwan application serial no. 99141519, filed Nov. 30, 2010. The entirety of the above-mentioned patent application is hereby incorporated by reference herein and made a part of this specification.

### BACKGROUND OF THE INVENTION

1. Field of the Invention

The invention generally relates to a projection apparatus, and more particularly, to a projection apparatus able to reduce stray light.

2. Description of Related Art

Traditionally, when a projection apparatus performs image projection, a light valve thereof converts an illumination light beam into an image light beam and reflects the image light beam to a projection lens, and then the image light beam is projected by the projection lens onto a screen to form images. Along with the volume of a projection apparatus tending to thin-shape design, however, distances between optical components inside the projection apparatus become shorter and shorter. As a result, when a light beam is transmitted inside the projection apparatus, the stray light is easily produced since the distances between the optical components thereof are too close. After the illumination light beam passes through a field lens, for example, a part of the illumination light beam would be reflected by the surface of the field lens and transmitted into the projection lens and finally form unexpected bright region (ghost shadow). On the other hand, when an illumination light beam is obliquely incident onto the light valve, the light radiation pattern (light spot) of an image light beam produced by the light valve would be deformed, which easily reduces the luminance of the projection apparatus and causes poor light uniformity on screen.

Taiwan Patent No. I330295 discloses a projection apparatus, which includes an illumination system, a reflective light valve, a field lens, and an imaging system. A reflective element can reflect an image light beam produced by the reflective light valve to a projection lens, wherein an optical axis of the projection lens is substantially perpendicular to the normal vector of the reflection surface of the reflective light valve. However, the above-mentioned architecture is unable to solve the deformation problem of the light spot.

### SUMMARY OF THE INVENTION

Accordingly, the invention is directed to a projection apparatus having good projection quality.

Other objectives and advantages of the invention should be further indicated by the disclosures of the invention.

To achieve one of, a part of or all of the above-mentioned objectives, an embodiment of the invention provides a projection apparatus. The projection apparatus includes an illumination system, a light valve, a projection lens, and a first reflective unit. The illumination system is capable of providing an illumination light beam. The light valve is disposed on a transmission path of the illumination light beam and the illumination light beam is transmitted to the light valve vertically, wherein the light valve is capable of converting the illumination light beam into an image light beam. The projection lens is disposed on a transmission path of the image light beam. The first reflective unit is disposed on the transmission path of the image light beam and located between the light valve and the projection lens, and the first reflective unit is capable of reflecting the image light beam from the light valve to the projection lens, wherein the image light beam reflected by the first reflective unit to the projection lens is perpendicular to the illumination light beam transmitted to the light valve.

In an embodiment of the invention, the light valve has a first optical axis and the illumination light beam transmitted to the light valve is parallel to the first optical axis. In an embodiment of the invention, the projection lens has a second optical axis and the first optical axis is not parallel to the second optical axis.

In an embodiment of the invention, the projection apparatus further includes a field lens, which is disposed on the transmission path of the illumination light beam and located between the illumination system and the light valve. In addition, the field lens is also disposed on the transmission path of the image light beam and located between the light valve and the first reflective unit.

In an embodiment of the invention, the projection apparatus further includes a light-uniforming device, which is disposed on the transmission path of the illumination light beam and located between the illumination system and the light valve. In an embodiment of the invention, the light-uniforming device is a light integration rod. In an embodiment of the invention, the light-uniforming device includes at least one lens array.

In an embodiment of the invention, the projection apparatus further includes a condenser lens, which is disposed on the transmission path of the illumination light beam and located between the illumination system and the light valve.

In an embodiment of the invention, the first reflective unit includes a plane mirror or a curved mirror.

In an embodiment of the invention, the projection apparatus further includes a second reflective unit, which is disposed on the transmission path of the illumination light beam and located between the illumination system and the light valve, and the illumination light beam from the illumination system is capable of being reflected by the second reflective unit so as to be transmitted to the light valve vertically. In an embodiment of the invention, the second reflective unit includes a plane mirror or a curved mirror.

In an embodiment of the invention, the illumination system includes a white light source.

In an embodiment of the invention, the illumination system includes a first light source, a second light source, and a light-combining device. The first light source is capable of providing a first color light beam and a second color light beam. The second light source is capable of providing a third color light beam. The light-combining device is capable of reflecting the first color light beam and the second color light beam, while the third color light beam is capable of passing through the light-combining device. In an embodiment of the invention, the projection apparatus further includes a first lens and a second lens. The first lens is disposed on a transmission path of the first color light beam and the second color light beam and located between the first light source and the light-combining device. The second lens is disposed on a transmission path of the third color light beam and located between the second light source and the light-combining device. In an embodiment of the invention, the light-combining device includes a first reflective element and a second reflective element. The first reflective element reflects the first color light beam. The second reflective element and the first reflective element are disposed side-by-side and not in cross, and the second reflective element reflects the second color light beam, wherein the third color light beam passes through the first reflective element and the second reflective element. In an embodiment of the invention, the first light source and the second light source are respectively a light emitting diode (LED) or LED array.

In an embodiment of the invention, the illumination system includes a first light source, a second light source, a third light source, and a light-combining device. The first light source is capable of providing a first color light beam. The second light source is capable of providing a second color light beam. The third light source is capable of providing a third color light beam. The light-combining device is capable of reflecting the first color light beam and the second color light beam, while the third color light beam is capable of passing through the light-combining device.

In an embodiment of the invention, the projection apparatus further includes a first lens, a second lens, and a third lens. The first lens is disposed on the transmission path of the first color light beam and located between the first light source and the light-combining device. The second lens is disposed on the transmission path of the second color light beam and located between the second light source and the light-combining device. The third lens is disposed on the transmission path of the third color light beam and located between the third light source and the light-combining device. In an embodiment of the invention, the light-combining device includes a first reflective element and a second reflective element. The first reflective element reflects the first color light beam. The second reflective element and the first reflective element are disposed in cross and the second reflective element reflects the second color light beam, wherein the third color light beam passes through the first reflective element and the second reflective element. In an embodiment of the invention, the first light source, the second light source and the third light source are respectively an LED.

Based on the depiction above, the embodiments of the invention may achieve at least one of the following advantage or effect. The projection apparatus of the embodiments makes the illumination light beam vertically (normally) incident onto the light valve so that the light radiation pattern (light spot) of the image light beam produced by the light valve will not be deformed and thereby a better projection frame, for example, better image luminance, is presented when the projection apparatus is projecting images. In addition, in order to reduce the chance for the ghost shadow light beam produced from the surface of the field lens to enter the projection lens, the invention takes a scheme that the image light beam transmitted to the projection lens is perpendicular to the illumination light beam transmitted to the light valve, so that the ghost shadow light beam less enters the projection lens which makes the projection apparatus have better optical projection quality.

Other objectives, features and advantages of the invention will be further understood from the further technological features disclosed by the embodiments of the invention wherein there are shown and described preferred embodiments of this invention, simply by way of illustration of modes best suited to carry out the invention.

In order to make the aforementioned and other features and advantages of the invention comprehensible, several exemplary embodiments accompanied with figures are described in detail below.

### BRIEF DESCRIPTION OF THE DRAWINGS

FIG. 1 is a diagram of a projection apparatus according to an embodiment of the invention.

FIG. 2 is a diagram showing a ghost shadow light beam produced when the illumination light beam of the projection apparatus of FIG. 1 is transmitted to a field lens.

FIG. 3 is a diagram of a projection apparatus according to another embodiment of the invention.

FIG. 4 is a diagram of a projection apparatus according to yet another embodiment of the invention.

FIG. 5 is a diagram of a projection apparatus according to yet another embodiment of the invention.

FIG. 6 is a diagram of a projection apparatus according to yet another embodiment of the invention.

FIGS. 7A and 7B are two diagrams respectively showing an illumination system according to different implementation configurations.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

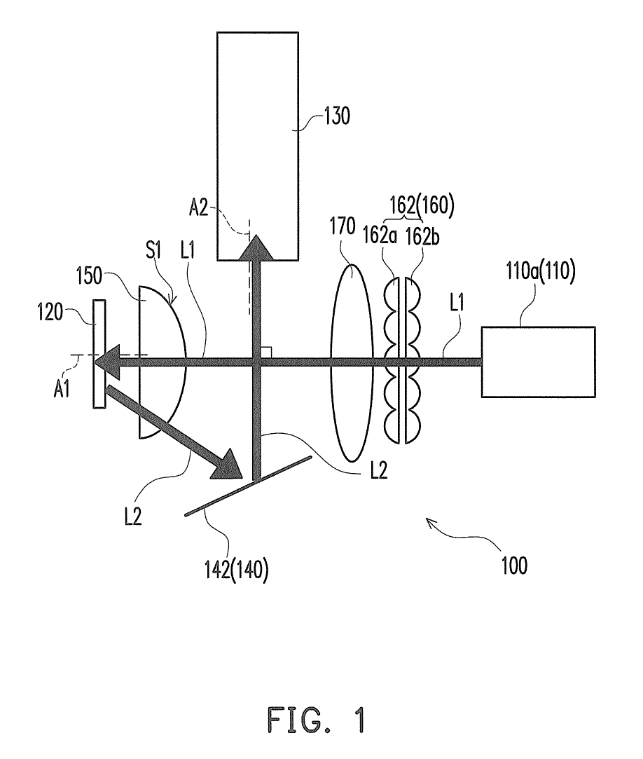

FIG. 1 is a diagram of a projection apparatus according to an embodiment of the invention. Referring to FIG. 1, a projection apparatus 100 of the embodiment includes an illumination system 110, a light valve 120, a projection lens 130, and a first reflective unit 140. The illumination system 110 is capable of providing an illumination light beam L1. In the embodiment, the illumination system 110 includes at least one light source, and the light source may be an LED light source, an LED array light source, an ultra high pressure lamp (UHP lamp) or other appropriate light sources.

The light valve 120 is disposed on a transmission path of the illumination light beam L1 and the illumination light beam L1 is vertically incident onto the light valve 120, wherein the light valve 120 is capable of converting the illumination light beam L1 into an image light beam L2. In the embodiment, the light valve 120 may have a first optical axis A1 and the first optical axis A1 may be the normal vector of the light valve 120. With the above-mentioned lay out, when the illumination light beam L1 transmitted to the light valve 120 is parallel to the first optical axis A1, the illumination light beam L1 is capable of being vertically incident onto the light valve 120, i.e., the illumination light beam L1 is normally incident onto the light valve 120. In general speaking, when an illumination light beam is obliquely incident onto a light valve, the light radiation pattern (light spot) of the image light beam produced by the light valve would be deformed, which easily reduces the luminance of the projection apparatus and causes poor light uniformity on screen. To avoid the above-mentioned problem, in the projection apparatus 100 of the embodiment, the illumination light beam L1 provided by the illumination system 110 is vertically incident onto the light valve 120, so that the light radiation pattern (light spot) of the image light beam L2 produced by the light valve 120 would not be deformed and thereby the image frame projected by the projection apparatus 100 may have better performance, for example, better frame luminance. In the embodiment, the light valve 120 is, for example, digital micro-mirror device (DMD) for explanation purpose. In other embodiments, however, the light valve 120 may be liquid-crystal-on-silicon panel (LCOS panel) as well.

Both the projection lens 130 and the first reflective unit 140 are disposed on the transmission path of the image light beam L2, and the first reflective unit 140 is located between the light valve 120 and the projection lens 130. In the embodiment, the first reflective unit 140 is, for example, a plane mirror 142 shown in FIG. 1, for explanation purpose. The first reflective unit 140 may be an optical component such as a total internal reflection prism (TIR prism) according to the requirement of the user and the design for reflecting the image light beam L2 to the projection lens 130. In more details, the light valve 120 converts the illumination light beam L1 into the image light beam L2, followed by transmitting the image light beam L2 to the first reflective unit 140, where the first reflective unit 140 reflects the image light beam L2 to the projection lens 130 for projecting frames. In particular, the image light beam L2 reflected by the first reflective unit 140 is capable of being perpendicular to the illumination light beam L1 transmitted to the light valve 120.

Specifically, the projection lens 130 may have a second optical axis A2, wherein the image light beam L2 reflected by the first reflective unit 140 is capable of being parallel to the second optical axis A2 of the projection lens 130 and enter the projection lens 130. Thus, the first optical axis A1 of the light valve 120 is not parallel to the second optical axis A2 of the projection lens 130, i.e., the light valve 120 and the projection lens 130 are substantially not located on the same optical axis.

In the embodiment, the projection apparatus 100 may further include a field lens 150 disposed on the transmission path of the illumination light beam L1 and located between the illumination system 110 and the light valve 120, wherein the field lens 150 is also disposed on the transmission path of the image light beam L2 and located between the light valve 120 and the first reflective unit 140. In more details, the field lens 150 may be used to converge the illumination light beam L1 from the illumination system 110 onto the light valve 120 and be capable of transmitting the image light beam L2 produced by the light valve 120 to the first reflective unit 140.

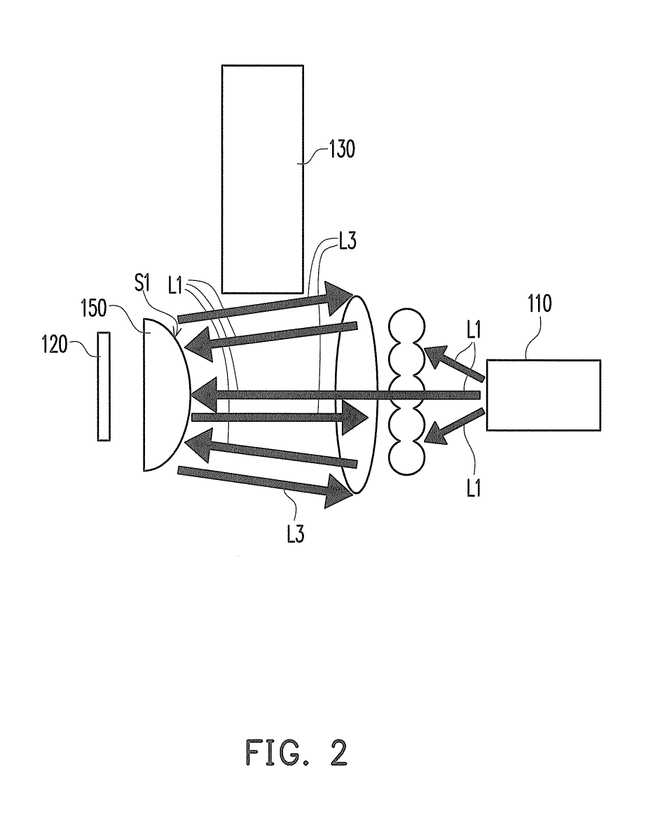

Usually, the optical coating film is unable to be penetrated fully (corresponding to 0% reflective index). Therefore, when the illumination light beam L1 is transmitted from the illumination system 110 to the light valve 120, a part of the illumination light beam L1 would be reflected on a surface S1 of the field lens 150 and produce a ghost shadow light beam L3, as shown by FIG. 2. For depiction convenience, FIG. 2 only shows the ghost shadow light beam produced as the illumination light beam of the projection apparatus of FIG. 1 is transmitted to the field lens and the relevant parts, while the other irrelevant optical components in the FIG. 1 are omitted.

In the embodiment, the optical axis A1 of both the light valve 120 and the field lens 150 and the optical axis A2 of the projection lens 130 are not located on the same optical axis, wherein in the embodiment, the optical axis A1 of both the light valve 120 and the field lens 150 is, for example, perpendicular to the optical axis A2 of the projection lens 130. Hence, when the light valve 120 is off-state, the ghost shadow light beam L3 from the surface S1 of the field lens 150 may not directly enter the projection lens 130 to produce unexpected bright region (ghost shadow) on the projection frame. In other words, in the projection apparatus 100 of the embodiment, the illumination light beam L1 transmitted to the light valve 120 is perpendicular to the image light beam L2 transmitted to the projection lens 130. Thus, the optical axis A1 of both the light valve 120 and the field lens 150 and the optical axis A2 of the projection lens 130 are not located on the same optical axis, which may reduce the chance for the ghost shadow light beam L3 to enter the projection lens 130 so as to have a better projection frames of the projection apparatus 100.

In the embodiment, the projection apparatus 100 may include a light-uniforming device 160, which is disposed on the transmission path of the illumination light beam L1 and located between the illumination system 110 and the light valve 120. In the embodiment, the light-uniforming device 160 includes at least one lens array 162. Specifically, the lens array 162 may include two sub-lens arrays 162a and 162b, which not only improve the light uniformity of the illumination light beam L1 passing through the lens array 162, but also adjust the light radiation pattern of the illumination light beam L1 transmitted to the light valve 120.

In more details, if the light valve 120 has a rectangular shape, the light radiation pattern of the illumination light beam L1 transmitted to the light valve 120 is preferably rectangular shape too. The light radiation pattern of the illumination light beam L1 may be adjusted by means of the light-uniforming device 160. In addition, the projection apparatus 100 may also include a condenser lens 170, which is disposed on the transmission path of the illumination light beam L1 and located between the illumination system 110 and the light valve 120. In the embodiment, the condenser lens 170 is mainly for further converging the illumination light beam L1 passing through the light-uniforming device 160 so as to avoid the light radiation pattern of the illumination light beam L1 prior being transmitted to the light valve 120 from getting deformation due to the divergence of the light beam and thereby avoid affecting the irradiation area and the efficiency for the illumination light beam L1 to irradiate the light valve 120.

Based on the depiction above, in the projection apparatus 100 of the embodiment, the illumination light beam L1 is vertically (normally) incident onto the light valve 120, so that the light radiation pattern (light spot) of the image light beam L2 produced by the light valve 120 would not get deformation, and thereby better projection frames, for example, the frames with better image luminance, are produced when the projection apparatus 100 projects images. Besides, in order to avoid the ghost shadow light beam L3 from the surface S1 of the field lens 150 from entering the projection lens 130 to produce unexpected bright region (ghost shadow) on the projection frame, the embodiment further makes the illumination light beam L1 transmitted to the light valve 120 in the projection apparatus 100 perpendicular to the image light beam L2 transmitted to the projection lens 130 so as to reduce the chance for the ghost shadow light beam L3 to enter the projection lens 130 and furthermore make the projection apparatus 100 have optical projection quality with high efficiency.

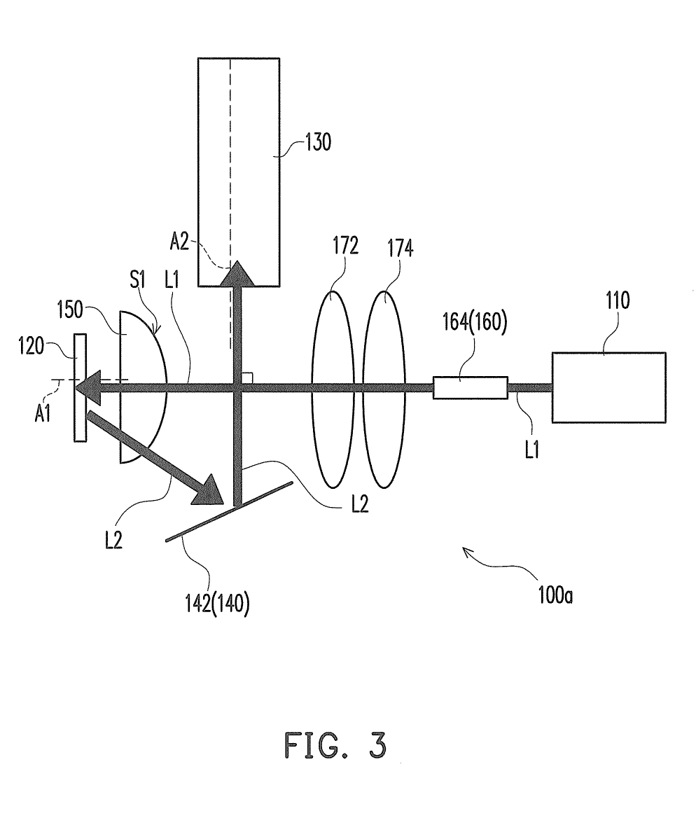

FIG. 3 is a diagram of a projection apparatus according to another embodiment of the invention. Referring to FIGS. 1 and 3, the projection apparatus 100a of the embodiment adopts the same idea as the above-mentioned projection apparatus 100 and the similar structure except that the light-uniforming device 160 of the projection apparatus 100a is a light integration rod 164. In more details, the light integration rod 164 not only improves the light uniformity of the illumination light beam L1, but also adjusts the light radiation pattern of the illumination light beam L1 in association with the shape of the light valve 120. In addition, a plurality of condenser lenses 172 and 174 (for example, two to four condenser lenses are used, not shown therein) are employed in association with the light integration rod 164 to improve the image quality.

In the same way, since the projection apparatus 100a adopts the architecture and the idea mentioned in the above-mentioned projection apparatus 100, the projection apparatus 100a of the embodiment has the forgoing advantage of the projection apparatus 100, which is omitted to describe.

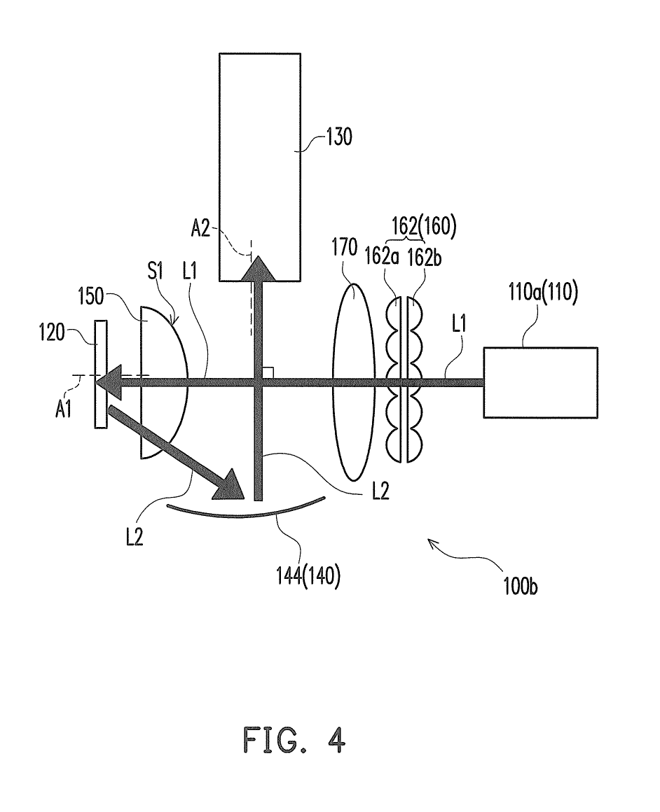

FIG. 4 is a diagram of a projection apparatus according to yet another embodiment of the invention. Referring to FIGS. 1 and 4, the projection apparatus 100b of the embodiment adopts the same idea and the similar structure of the above-mentioned projection apparatus 100 except that the first reflective unit 140 may be a curved mirror 144. Besides, the first reflective unit 140 may be also other optical components (for example, wedge prism), which is determined by the requirement of the user and the design and the invention is not limited to.

In the same way, since the projection apparatus 100b adopts the architecture and the idea mentioned in the above-mentioned projection apparatus 100, the projection apparatus 100b of the embodiment has the forgoing advantage of the projection apparatus 100, which is omitted to describe.

It should be noted that the projection apparatus 100b may also adopt the structure design of the above-mentioned projection apparatus 100a. That is to say, the lens array 162 of the light-uniforming device 160 in the projection apparatus 100b may be the above-mentioned light integration rod 164 for improving the image quality, which is determined by the requirement of the user and the design and the invention is not limited to.

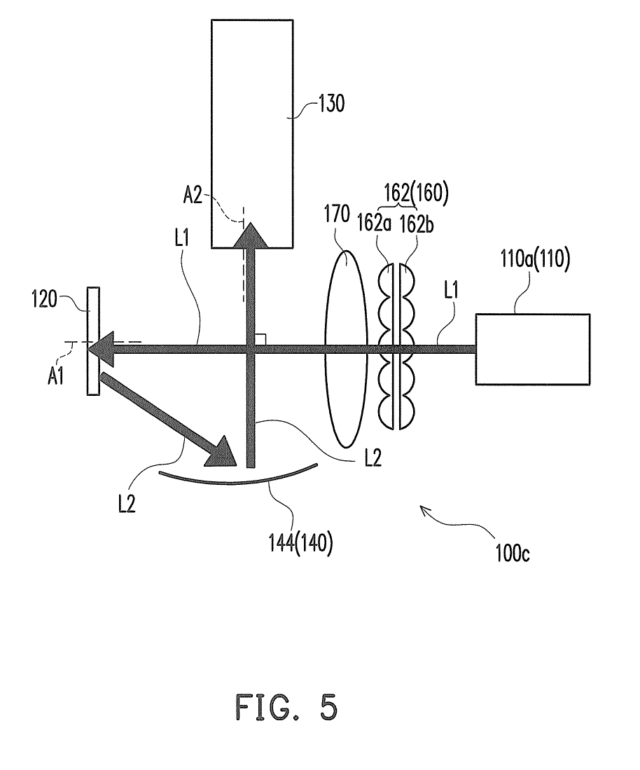

FIG. 5 is a diagram of a projection apparatus according to yet another embodiment of the invention. Referring to FIGS. 1 and 5, the projection apparatus 100c of the embodiment adopts the same idea and the similar structure of the above-mentioned projection apparatus 100b except that the projection apparatus 100c does not have the above-mentioned field lens 150. In other words, the projection apparatus of the embodiment may also use merely a curved mirror 144 to converge the image light beam L2 and transmit the image light beam L2 into the projection lens 130. Except the mentioned above, the projection apparatus 100c of the embodiment has the forgoing advantage of the projection apparatus 100b, which is omitted to describe.

It should be noted that the projection apparatus 100c may also adopt the structure design of the above-mentioned projection apparatus 100a, i.e., in the projection apparatus 100c, the lens array 162 of the light-uniforming device 160 may be implemented by the above-mentioned light integration rod 164 for improving the image quality, which is determined by the requirement of the user and the design and the invention is not limited to.

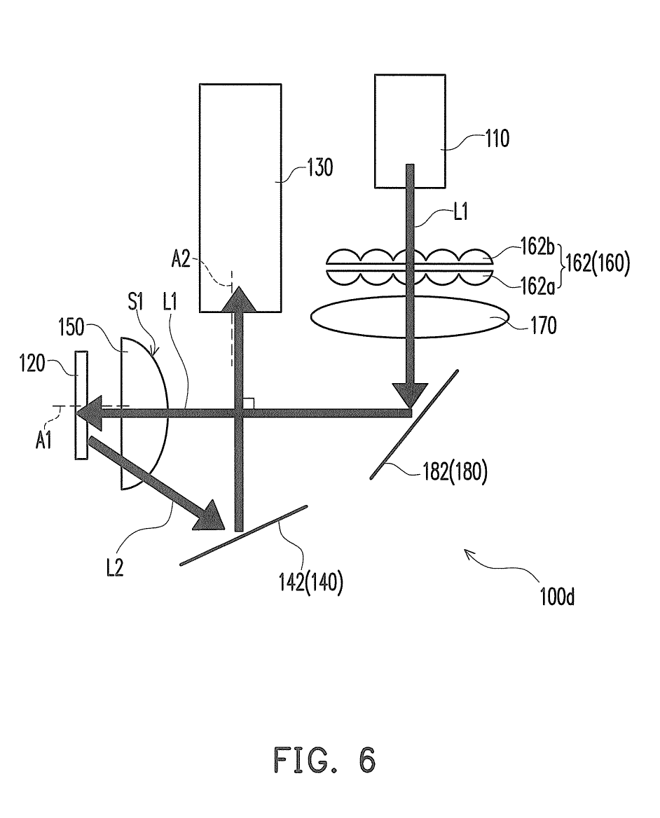

FIG. 6 is a diagram of a projection apparatus according to yet another embodiment of the invention. Referring to FIGS. 1 and 6, the projection apparatus 100d of the embodiment adopts the same idea and the similar structure of the above-mentioned projection apparatus 100 except that the projection apparatus 100d further includes a second reflective unit 180, wherein the second reflective unit 180 is disposed on the transmission path of the illumination light beam L1 and located between the illumination system 110 and the light valve 120. In the embodiment, the illumination light beam L1 from the illumination system 110 is capable of being reflected by the second reflective unit 180 so as to be vertically incident onto the light valve 120, wherein the second reflective unit 180 is, for example, a plane mirror 182 shown in FIG. 6 for explanation purpose. In other unshown embodiments, the second reflective unit 180 may adopt the architecture of an optical component such as a TIR prism or the above-mentioned curved mirror 164 of FIG. 4. In more details, since the second reflective unit 180 in the projection apparatus 100d is disposed on the transmission path of the illumination light beam L1 and located between the illumination system 110 and the light valve 120, so that the space may be effectively utilized on designing the light paths, which is helpful to effectively reduce the overall dimension thereof and suitable for the architecture used in a pico-projector. In other words, the projection apparatus 100d of the embodiment is advantageous not only in having smaller overall dimension but also in having optical projection quality with high efficiency.

In the same way, since the projection apparatus 100d adopts the architecture and the idea mentioned in the above-mentioned projection apparatus 100, the projection apparatus 100d of the embodiment has the forgoing advantage of the projection apparatus 100, which is omitted to describe.

It should be noted that the projection apparatus 100d may also optionally adopt the structure design mentioned by the above-mentioned projection apparatus 100a, 100b or 100c, or a combined structure design mentioned in the projection apparatuses 100a, 100b and 100c, which is determined by the requirement of the user and the design and the invention is not limited to.

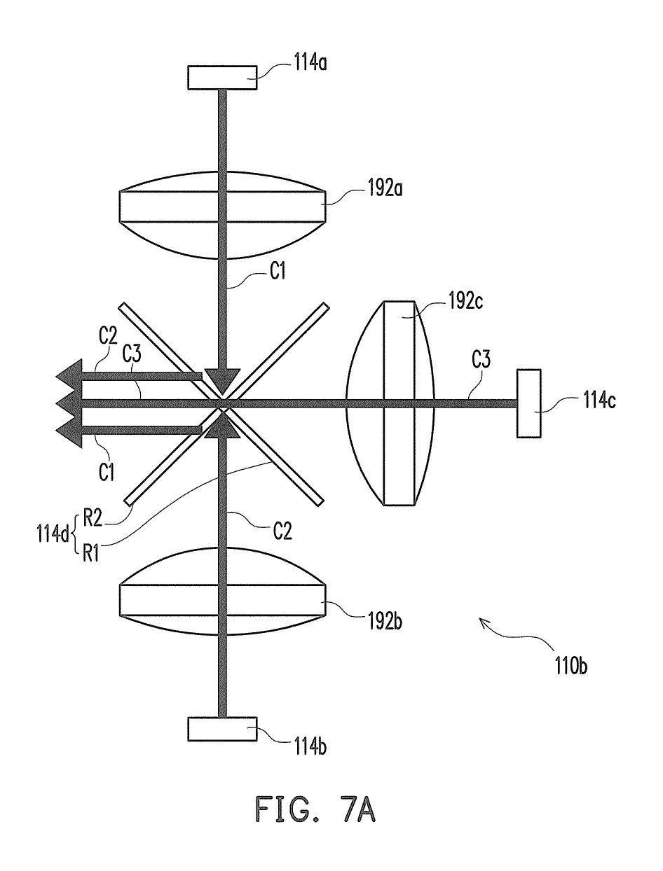

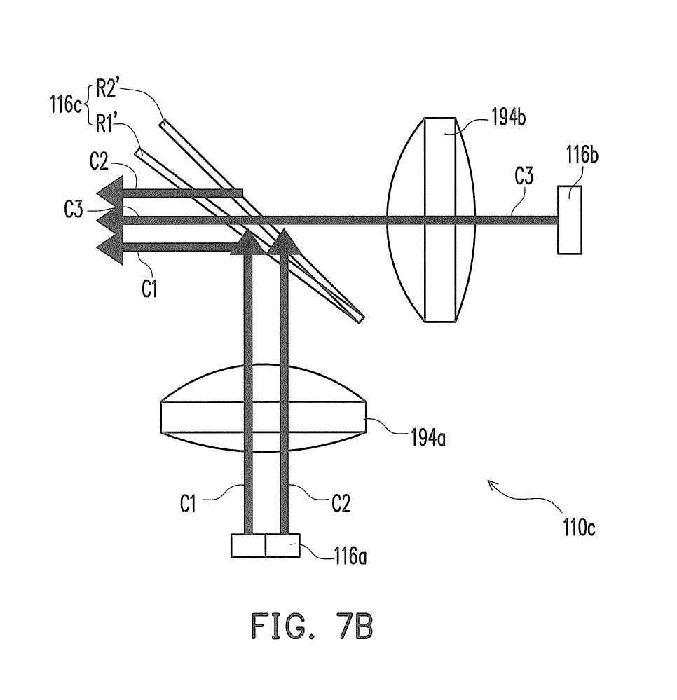

In the above-mentioned projection apparatuses 100, 100a, 100b, 100c and 100d, the illumination system 110 is, for example, a white light source 110a for explanation purpose. In other embodiments, the above-mentioned illumination system 110 may be the illumination system 110b or 110c respectively shown by FIGS. 7A and 7B, which are explained as following.

In the implementation configuration given by FIG. 7A, the illumination system 110b includes a first light source 114a, a second light source 114b, a third light source 114c, and a light-combining device 114d. The first light source 114a is capable of providing a first color light beam C1, the second light source 114b is capable of providing a second color light beam C2, and the third light source 114c is capable of providing a third color light beam C3. The light-combining device 114d is capable of reflecting the first color light beam C1 and the second color light beam C2, while the third color light beam C3 is capable of passing through the light-combining device 114d. In more details, the light-combining device 114d includes a first reflective element R1 and a second reflective element R2, wherein the first reflective element R1 and the second reflective element R2 are disposed in cross. The first reflective element R1 reflects the first color light beam C1, the second reflective element R2 reflects the second color light beam C2 and the third color light beam C3 passes through the first reflective element R1 and the second reflective element R2.

As mentioned before, in the illumination system 110b, the first light source 114a is, for example, an LED emitting red light, the second light source 114b is, for example, an LED emitting blue light and the third light source 114c is, for example, an LED emitting green light. Specifically, the first color light beam C1 and the second color light beam C2 may be respectively reflected by the first reflective element R1 and the second reflective element R2 by means of the light-combining device 114d, the third color light beam C3 may pass through the first reflective element R1 and the second reflective element R2, and finally, the three color light beams are combined into a white light beam.

The first light source 114a, the second light source 114b, and the third light source 114c in the above-mentioned illumination system 110b are, for example, three independent devices. In other embodiments, the illumination system may adopt a single light source able to emit three color light beams (not shown), wherein the single light source in association with the light-combining device 114d including the first reflective element R1 and the second reflective element R2 may substantially achieve the same effect of the illumination system 110b.

It should be noted that the illumination system 110b may also include a first lens 192a, a second lens 192b, and a third lens 192c. The first lens 192a is disposed on the transmission path of the first color light beam C1 and located between the first light source 114a and the light-combining device 114d. The second lens 192b is disposed on the transmission path of the second color light beam C2 and located between the second light source 114b and the light-combining device 114d. The third lens 192c is disposed on the transmission path of the third color light beam C3 and located between the third light source 114c and the light-combining device 114d. Specifically, the first lens 192a, the second lens 192b, and the third lens 192c are mainly used to respectively converge the first color light beam C1, the second color light beam C2 and the third color light beam C3 onto the light-combining device 114d.

In the implementation configuration given by FIG. 7B, the illumination system 110c includes a first light source 116a, a second light source 116b, and a light-combining device 116c. The first light source 116a is capable of providing a first color light beam C1 and a second color light beam C2, and the second light source 116b is capable of providing a third color light beam C3. The light-combining device 116c is capable of reflecting the first color light beam C1 and the second color light beam C2 both from the first light source 116a, while the third color light beam C3 from the second light source 116b is capable of passing through the light-combining device 116c. In more details, the light-combining device 116c includes a first reflective element R1′ and a second reflective element R2′, wherein the first reflective element R1′ and the second reflective element R2′ are disposed side by side and not in cross. The first reflective element R1′ reflects the first color light beam C1, the second reflective element R2′ reflects the second color light beam C2 and the third color light beam C3 passes through the first reflective element R1′ and the second reflective element R2′.

As mentioned before, in the illumination system 110c, the first light source 116a is, for example, an LED able to emit bi-colors light, and the second light source 116b is, for example, an LED able to emit mono-color light. In more details, the first color light beam C1, the second color light beam C2, and the third color light beam C3 may be respectively red light, blue light and green light. The first color light beam C1 and the second color light beam C2 are respectively reflected by the first reflective element R1′ and the second reflective element R2′ by means of the light-combining device 116c, while the third color light beam C3 may pass through the first reflective element R1′ and the second reflective element R2′, and finally, the three color light beams are combined into a white light beam.

The first light source 116a and the second light source 116b in the above-mentioned illumination system 110c are, for example, two independent devices. In other embodiments, the illumination system may adopt a single light source able to emit three color light beams (not shown), wherein the single light source in association with the light-combining device 116c including the first reflective element R1′ and the second reflective element R2′ may substantially achieve the same effect of the illumination system 110c.

The illumination system 110c in the embodiment may also include a first lens 194a and a second lens 194b. The first lens 194a is disposed on the transmission path of the first color light beam C1 and the second color light beam C2 and located between the first light source 116a and the light-combining device 116c. The second lens 194b is disposed on the transmission path of the third color light beam C3 and located between the second light source 116b and the light-combining device 116c. In the same way, the first lens 194a and the second lens 194b are mainly used to respectively converge the first color light beam C1, the second color light beam C2, and the third color light beam C3 onto the light-combining device 116c.

In addition, in other embodiments, a light-combining device having three reflective elements may be adopted (not shown), wherein the three reflective elements are disposed side by side and not in cross and may respectively reflect the three color light beams. Certainly, the invention does not limit the constitution structure and the quantity of the light sources for producing the three color light beams.

It should be noted that the above-mentioned illumination systems (for example, 110b, 110c, etc.) may be applied in any architecture among the above-mentioned projection apparatuses 100, 100a, 100b, 100c and 100d, which is omitted to describe.

In summary, the projection apparatus of the invention have at least the following advantage. First, the illumination light beam is vertically (normally) incident onto the light valve so that the light radiation pattern (light spot) of the image light beam produced by the light valve will not be deformed and thereby a better projection frame, for example, better image luminance, is presented when the projection apparatus is projecting images. In addition, in order to avoid the ghost shadow light beam produced from the surface of the field lens from entering the projection lens and avoid producing the unexpected bright region (ghost shadow) on the projection frame, the invention takes a scheme that the illumination light beam transmitted to the light valve is perpendicular to the image light beam transmitted to the projection lens so as to reduce the chance for the ghost shadow light beam to enter the projection lens which makes the projection apparatus have optical projection quality with high efficiency.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter. In addition, any one of the embodiments or claims of the invention is not necessarily to achieve all of the above-mentioned objectives, advantages or features. The abstract and the title herein are used to assist searching the documentations of the relevant patents, not to limit the claim scope of the invention.

Each of the terms “first”, “second”, and “third” is only a nomenclature used to modify its corresponding element. These terms are not used to set up the upper limit or lower limit of the number of elements, wherein the element is, for example, a reflective unit.

What is claimed is:

1. A projection apparatus, comprising:
an illumination system, capable of providing an illumination light beam;
a light valve, disposed on a transmission path of the illumination light beam, wherein the illumination light beam is transmitted to the light valve vertically and the light valve is capable of converting the illumination light beam into an image light beam;
a projection lens, disposed on a transmission path of the image light beam; and
a first reflective unit, disposed on the transmission path of the image light beam and located between the light valve and the projection lens, wherein the first reflective unit is capable of reflecting the image light beam from the light valve to the projection lens, and the image light beam reflected by the first reflective unit to the projection lens is perpendicular to the illumination light beam transmitted from the illumination system to the light valve.

2. The projection apparatus as claimed in claim 1, wherein the light valve has a first optical axis and the illumination light beam transmitted from the illumination system to the light valve is parallel to the first optical axis.

3. The projection apparatus as claimed in claim 2, wherein the projection lens has a second optical axis and the first optical axis is not parallel to the second optical axis.

4. The projection apparatus as claimed in claim 1, further comprising:
a field lens, disposed on the transmission path of the illumination light beam and located between the illumination system and the light valve, wherein the field lens is also disposed on the transmission path of the image light beam and located between the light valve and the first reflective unit.

5. The projection apparatus as claimed in claim 1, further comprising:
a light-uniforming device, disposed on the transmission path of the illumination light beam and located between the illumination system and the light valve.

6. The projection apparatus as claimed in claim 5, wherein the light-uniforming device is a light integration rod.

7. The projection apparatus as claimed in claim 5, wherein the light-uniforming device comprises at least one lens array.

8. The projection apparatus as claimed in claim 1, further comprising:
a condenser lens, disposed on the transmission path of the illumination light beam and located between the illumination system and the light valve.

9. The projection apparatus as claimed in claim 1, wherein the first reflective unit comprises a plane mirror or a curved mirror.

10. The projection apparatus as claimed in claim 1, further comprising:
a second reflective unit, disposed on the transmission path of the illumination light beam and located between the illumination system and the light valve, and the illumination light beam from the illumination system is capable of being reflected by the second reflective unit so as to be transmitted to the light valve vertically.

11. The projection apparatus as claimed in claim 10, wherein the second reflective unit comprises a plane mirror or a curved mirror.

12. The projection apparatus as claimed in claim 1, wherein the illumination system comprises a white light source.

13. The projection apparatus as claimed in claim 1, wherein the illumination system comprises:
a first light source, capable of providing a first color light beam and a second color light beam;
a second light source, capable of providing a third color light beam; and
a light-combining device, capable of reflecting the first color light beam and the second color light beam, wherein the third color light beam is capable of passing through the light-combining device.

14. The projection apparatus as claimed in claim 13, further comprising:
a first lens, disposed on a transmission path of the first color light beam and the second color light beam and located between the first light source and the light-combining device; and
a second lens, disposed on a transmission path of the third color light beam and located between the second light source and the light-combining device.

15. The projection apparatus as claimed in claim 13, wherein the light-combining device comprises:
a first reflective element, reflecting the first color light beam; and
a second reflective element, disposed with the first reflective element side-by-side and not in cross and reflecting the second color light beam, wherein the third color light beam passes through the first reflective element and the second reflective element.

16. The projection apparatus as claimed in claim 13, wherein the first light source and the second light source are respectively a light emitting diode or a light emitting diode array.

17. The projection apparatus as claimed in claim 1, wherein the illumination system comprises:
a first light source, capable of providing a first color light beam;
a second light source, capable of providing a second color light beam;
a third light source, capable of providing a third color light beam; and
a light-combining device, capable of reflecting the first color light beam and the second color light beam, wherein the third color light beam is capable of passing through the light-combining device.

18. The projection apparatus as claimed in claim 17, further comprising:
a first lens, disposed on a transmission path of the first color light beam and located between the first light source and the light-combining device;
a second lens, disposed on a transmission path of the second color light beam and located between the second light source and the light-combining device; and
a third lens, disposed on a transmission path of the third color light beam and located between the third light source and the light-combining device.

19. The projection apparatus as claimed in claim 17, wherein the light-combining device comprises:
a first reflective element, reflecting the first color light beam; and
a second reflective element, disposed with the first reflective element in cross and reflecting the second color light beam, wherein the third color light beam passes through the first reflective element and the second reflective element.

20. The projection apparatus as claimed in claim 17, wherein the first light source, the second light source and the third light source are respectively a light emitting diode or a light emitting diode array.
